(19) United States
(12) Patent Application Publication
(10) Pub. No.: US 2019/0149958 A1
(43) Pub. Date: May 16, 2019

(54) Methods, Apparatuses and Computer Program for Transmission Format/Retransmission Adaptation in Wireless Network

(71) Applicant: Telefonaktiebolaget LM Ericsson (publ), Stockohlm (SE)

(72) Inventors: Zhang Zhang, Beijing (CN); Marco Belleschi, Solna (SE); Qianxi Lu, Beijing (CN); Stefano Sorrentino, Solna (SE)

(21) Appl. No.: 16/300,647

(22) PCT Filed: May 4, 2017
(86) PCT No.: PCT/SE2017/050433

§ 371 Date: Nov. 12, 2018

(30) Foreign Application Priority Data
May 13, 2016 (CN) PCT/CN2016/082018

(51) Int. Cl. H04W 4/06; H04W 4/029; H04W 4/20; H04L 1/18; H04W 72/00

(52) U.S. Cl. CPC H04W 4/06; H04W 4/029; H04W 72/005; H04L 1/1812; H04W 4/20

(57) ABSTRACT

The disclosure provides a method in a User Equipment, UE. The method comprises determining an area in which the UE resides based upon the UE's location and area definition information. The method further comprises determining a set of broadcast services of interest based upon the determined area and bearer to area mapping information. The method further comprises transmitting an indication message to a network node when the set of broadcast services of interest is changed due to a change of the UE's location. With the proposed method, transmission efficiency and system performance are improved.

### TECHNICAL FIELD

The disclosure relates generally to wireless communications, and more particularly, to devices and methods for transmission format and/or retransmission adaptation in a wireless network.

### BACKGROUND

LTE standard has been extended with support of device to device (D2D) (specified as “sidelink”) features targeting both commercial and Public Safety applications. Some applications enabled by Rel-12 LTE are device discovery, where devices are able to sense the proximity of another device and associated application by broadcasting and detecting discovery messages that carry device and application identities. Another application consists of direct communication based on physical channels terminated directly between devices.

One of the potential extensions for the device to device work consists of support of V2x communication, which includes any combination of direct communication between vehicles, pedestrians and infrastructure. FIG. 1 shows V2x scenarios with an LTE network. V2x communication may take advantage of a NW infrastructure, when available, but at least basic V2x connectivity should be possible even in case of lack of network coverage. Providing an LTE-based V2x interface may be economically advantageous because of the LTE economies of scale and it may enable tighter integration between communications with the NW infrastructure (V2I) and V2P and V2V communications, as compared to using a dedicated V2x technology.

V2x communications may carry both non-safety and safety information, where each of the applications and services may be associated with specific requirements sets, e.g., in terms of latency, reliability, capacity, etc. SA1#69 recently agreed a new Rel-14 study on LTE support for V2X services to investigate the essential use cases and requirements for the following:
V2V (vehicle-to-vehicle): covering LTE-based communication between vehicles.
V2P (vehicle-to-pedestrian): covering LTE-based communication between a vehicle and a device carried by an individual (e.g. handheld terminal carried by a pedestrian, cyclist, driver or passenger).
V2I/N (vehicle-to-infrastructure/network): covering LTE-based communication between a vehicle and a roadside unit/network. A roadside unit (RSU) is a transportation infrastructure entity (e.g. an entity transmitting speed notifications) implemented in an eNodeB or a stationary UE.

The SA1 study considers both safety services and non-safety services and the possibility of using existing LTE technologies for unicast/multicast/broadcast communication. R13 RAN SI is approved recently to start, with the objectives to evaluate new functionalities needed to operate LTE-based V2X (V2V, V2I/N, and V2P), and to investigate potential enhancements for vehicular services. Most DL messages, no matter whether they are originated from the vehicle UEs (V2V) or from the network (V2I), are generally interesting for a group of UEs within a geographical area. Unicast cannot provide sufficient capacity when the traffic load becomes high, while broadcast/multicast appears as one natural option for efficient delivery. In LTE, the Multimedia Broadcast/Multicast Service (MBMS) was introduced to provide an efficient mode of delivery for both broadcast and multicast services over the core network. MBMS was available for LTE in the second release of the LTE specifications (Release 9), although the initial Release 8 physical layer specifications were already designed to support MBMS by including essential components to ensure forward-compatibility.

The LTE MBMS feature is largely based on that which was already available in UTRAN (from Release 6) and GERAN with both simplifications and enhancements. In the most general sense, broadcasting is the distribution of content to an audience of multiple users; in the case of mobile multimedia services an efficient transmission system for the simultaneous delivery of content to large groups of mobile users. Typical broadcast content can include newscasts, weather forecasts or live mobile television, now extended into LTE E-UTRAN system.

FIG. 2 shows network architecture for GCSE in the roaming scenario. As shown in FIG. 2, MBMS is a key component to enable group communication—GCSE (Group Communication System Enabler), where the key network entity includes the application server (AS) of GCS, where the traffic goes towards BM-SC (Broadcast-Multicast Service Centre), to MBMS GW (MBMS Gateway) to E-UTRAN to UE. Please note that here the service can be provided by either unicast or multi-cast in a flexible way, decided by application server GCS AS (where the unicast bearer is routed back to P-GW of H-PLMN in FIG. 2).

In addition, V2x is a local broadcast in a limited area, message from UE(s) close to cell center may only be interested by the UE(s) served by the same cell, while message from UE(s) close to cell border may be interested by the UE(s) served by multiple cells. For the former case a broadcast in a single cell or even an area smaller than a cell may be beneficial as it limits redundancy and MCS could be adapted according to radio characteristic in that area. HARQ retransmission could also be adapted so that it is performed only if there is UE(s) in that area that require retransmission. For the latter case, a MBSFN (like) transmission could be beneficial to boost signal strength and decrease interference. To handle these different cases a cluster based broadcasting is introduced where a cluster is in essence a group of (Rx) UE or (Rx) UE positions. Here, cluster Temporary Mobile Group Identity (TMGI) or mbms bearer is cluster related, i.e. the message only needs to be received in one or several relevant clusters depending on UE positions and the required communication range.

The purpose of sending MBMS interest indication is to inform E-UTRAN that the UE is receiving or is interested to receive MBMS service(s) via an (SC-) mbms radio bearer (MRB). An MBMS or SC-PTM capable UE in RRC_CONNECTED may initiate the procedure in several cases, including upon successful connection establishment, upon entering or leaving the service area, upon session start or stop, upon change of interest, upon change of priority between MBMS reception and unicast reception or upon change to a PCell broadcasting SystemInformationBlockType15.

Upon initiating the procedure, the UE shall transmit the MBMS Interest Indication message if the UE did not transmit the message since last entering RRC_CONNECTED state; or if the set of MBMS frequencies of interest has changed since the last transmission of the MBMS Interest Indication message; or if the set of MBMS services of interest is different from mbms-services included in the last transmission of the MBMS Interest Indication message (i.e. change of interests). It could be seen that the transmission of MBMS Interest Indication message is triggered by the changes in the system side.

The UE may include the following contents in the MBMS Interest Indication message:
mbms-FreqList and set it to include the set of MBMS frequencies of interest, if it is not empty
mbms-Priority if the UE prioritizes reception of all indicated MBMS frequencies above reception of any of the unicast bearers
mbms-Services and set it to indicate the set of MBMS services of interest if SIB 20 is broadcasted, each mbms service is identified by a TMGI.

The UE shall consider a MBMS service to be part of the MBMS services of interest if the UE is receiving or is interested to receive this service and one or more MBMS service area Identities (SAls) in the User Service Description (USD) for this service is included in System Information Block (SIB) Type15 for a frequency belonging to the set of MBMS frequencies of interest. Here, MBMS Service Area is the area within which data of a specific MBMS session are sent. It comprises of one or more MBMS SAls, and an MBMS SAI identifies a group of cells within a PLMN. With the exception of the specific MBMS SAI with value 0, the MBMS SAI shall be unique within a PLMN. Note that the network knows which TMGI(s) the UE is currently receiving as those are the TMGI(s) interested by the UE and currently being sent by the network.

### SUMMARY

To improve transmission format/retransmission adaptation in a wireless network, the following schemes are provided to enhance transmission efficiency and system performance.

In a first aspect of the disclosure, a method in a User Equipment, UE, for transmission format and/or retransmission adaptation is provided. The method comprises determining a cluster in which the UE resides based upon the UE's location and cluster definition information. The method further comprises determining a broadcast service identified by an identifier, which the UE should receive or is supposed to receive, based upon bearer to cluster mapping information. The method further comprises transmitting an indication message to a network node if change of the UE's location meets a certain condition, the indication message assisting the transmission format and/or retransmission adaptation for the broadcast service. With the proposed method, MCS/HARQ retransmission adaptation for cluster wise TMGI is achieved which improves transmission efficiency and system performance.

In a second aspect of the disclosure, a method in a network node for transmission format and/or retransmission adaptation is provided. The method comprises collecting, from a plurality of User Equipments, UEs, feedback messages for a plurality of broadcast services identified by a plurality of identifiers. The method further comprises classifying the collected feedback messages according to the broadcast services to which they correspond. The method further comprises performing transmission format and/or retransmission adaptation for a certain broadcast service according to the feedback messages classified to that broadcast service.

In a third aspect of the disclosure, a method in a network node for transmission format and/or retransmission adaptation is provided. The method comprises determining a cluster in which a User Equipment, UE, resides based upon the UE's location and cluster definition information. The method further comprises determining a broadcast service identified by an identifier, which shall be received by the UE, based upon bearer to cluster mapping information. The method further comprises performing transmission format and/or retransmission adaptation for the broadcast service.

In a fourth aspect of the disclosure, a method in a User Equipment, UE, for transmission format and/or retransmission adaptation is provided. The method comprises transmitting location of the UE to a network node in a wireless network.

The method further comprises receiving identifiers for identifying broadcast services available in a cluster or cluster(s). The method further comprises transmitting feedback messages for the identifiers to the network node. The method further comprises transmitting, if no retransmission is performed for a certain identifier for which a negative feedback message has been sent, an indication to the network node that the broadcast service for the certain identifier will no longer be received by the UE.

In a fifth aspect of the disclosure, a User Equipment, UE is provided which comprises a determining unit and a transmitting unit. The determining unit is configured to determine a cluster in which the UE resides based upon the UE's location and cluster definition information, and determine a broadcast service identified by an identifier, which the UE should receive or is supposed to receive, based upon bearer to cluster mapping information. The transmitting unit is configured to transmit an indication message to a network node if change of the UE's location meets a certain condition, the indication message assisting the transmission format and/or retransmission adaptation for the broadcast service. In a sixth aspect of the disclosure, a network node for transmission format and/or retransmission adaptation is provided. The network node comprises a collecting unit configured to collect, from a plurality of User Equipments, UEs, feedback messages for a plurality of broadcast services identified by a plurality of identifiers. The network node further comprises a classifying unit configured to classify the collected feedback messages according to the broadcast services to which they correspond. The network node further comprises an adapting unit configured to perform transmission format and/or retransmission adaptation for a certain broadcast service according to the feedback messages classified to that broadcast service.

In a seventh aspect of the disclosure, a network node for transmission format and/or retransmission adaptation is provided. The network node comprises a determining unit configured to determine a cluster in which a User Equipment, UE, resides based upon the UE's location and cluster definition information, and determine a broadcast service identified by an identifier, which shall be received by the UE, based upon bearer to cluster mapping information. The network node further comprises an adapting unit configured to perform transmission format and/or retransmission adaptation for the broadcast service.

In an eighth aspect of the disclosure, a User Equipment, UE is provided which comprises a receiving unit and a transmitting unit. The receiving unit is configured to receive identifiers for identifying broadcast services available in a cluster or cluster(s). The transmitting unit is configured to transmit location of the UE to a network node in a wireless network, transmit feedback messages for the identifiers to the network node, and transmit, if no retransmission is performed for a certain identifier for which a negative feedback message has been sent, an indication to the network node that the broadcast service for the certain identifier will no longer be received by the UE.

In a ninth aspect of the disclosure, a User Equipment, UE is provided which comprises a processing circuit and a memory circuit. The memory circuit contains instructions executable by the processing circuit whereby said UE is operative to perform the methods in accordance with the aspects of the disclosure.

In a tenth aspect of the disclosure, a network node is provided which comprises a processing circuit and a memory circuit. The memory circuit contains instructions executable by the processing circuit whereby said network node is operative to perform the methods in accordance with the aspects of the disclosure.

In an eleventh aspect of the disclosure, a method in a User Equipment, UE, is provided. The method comprises determining an area in which the UE resides based upon the UE's location and area definition information. The method further comprises determining a set of broadcast services of interest based upon the determined area and bearer to area mapping information. The method further comprises transmitting an indication message to a network node when the set of broadcast services of interest is changed due to a change of the UE's location.

In a twelfth aspect of the disclosure, a User Equipment, UE, is provided. The UE comprises a determining unit configured to determine an area in which the UE resides based upon the UE's location and area definition information, and determine a set of broadcast services of interest based upon the determined area and bearer to area mapping information. The UE further comprises a transmitting unit configured to transmit an indication message to a network node when the set of broadcast services of interest is changed due to a change of the UE's location. In a thirteenth aspect of the disclosure, a method in a network node is provided.

The method comprises transmitting, to a User Equipment, UE, a configuration message for a light Multimedia Broadcast/Multicast Service, MBMS, indication message. The light MBMS indication message may include no information about MBMS frequencies of interest or priorities thereof. The method further comprises receiving, from the UE, the light MBMS indication message.

In a fourteenth aspect of the disclosure, a network node is provided. The network node comprises a transmitting unit configured to transmit, to a User Equipment, UE, a configuration message for a light Multimedia Broadcast/Multicast Service, MBMS, indication message. The light MBMS indication message may include no information about MBMS frequencies of interest or priorities thereof. The network node further comprises a receiving unit configured to receive, from the UE, the light MBMS indication message.

In a fifteenth aspect of the disclosure, a User Equipment, UE, is provided. The UE comprises a processing circuit and a memory circuit. The memory circuit contains instructions executable by the processing circuit whereby the UE is operative to: determine an area.in which the UE resides based upon the UE's location and area definition information; determine one or more broadcast services of interest based upon the determined area and bearer to area mapping information; and transmit an indication message to a network node when the one or more broadcast services of interest are changed due to a change of the UE's location.

In a sixteenth aspect of the disclosure, a network node is provided. The network node comprises a processing circuit and a memory circuit. The memory circuit contains instructions executable by the processing circuit whereby the network node is operative to: transmit, to a User Equipment, UE, a configuration message for a light Multimedia Broadcast/Multicast Service, MBMS, indication message, wherein the light MBMS indication message does not include information about MBMS frequencies of interest or priorities thereof; and receive, from the UE, the light MBMS indication message.

In a seventeenth aspect of the disclosure, a computer program comprising computer program code means is provided. The computer program code means may cause, when executed by at least one processing circuit, the at least one processing circuit to perform the methods in accordance with the aspects of the disclosure.

In an eighteenth aspect of the disclosure, a computer readable medium is provided. The computer readable medium has stored there on the computer program in accordance with the seventeenth aspect of the disclosure. The proposed schemes can improve transmission format/retransmission adaptation in a wireless network and enhance transmission efficiency and system performance.

### BRIEF DESCRIPTION OF THE DRAWINGS

The above and other objects, features and advantages will be more apparent from the following description of embodiments with reference to the figures, in which:

FIG. 1 is a schematic diagram showing V2x scenarios with an LTE network;

FIG. 2 is a schematic diagram showing network architecture for GCSE in the roaming scenario;

FIG. 3(a) is a flowchart illustrating a method in a UE for transmission lo format and/or retransmission adaptation according to an embodiment of the disclosure;

FIG. 3(b) is a flowchart illustrating a method in a UE according to an embodiment of the disclosure;

FIG. 4(a) is a flowchart illustrating a method in a network node for transmission format and/or retransmission adaptation according to an embodiment of the disclosure;

FIG. 4(b) is a flowchart illustrating a method in a network node according to an embodiment of the disclosure;

FIG. 5 is a flowchart illustrating a method in a network node for transmission format and/or retransmission adaptation according to an embodiment of the disclosure;

FIG. 6 is a flowchart illustrating a method in a UE for transmission format and/or retransmission adaptation according to an embodiment of the disclosure;

FIG. 7(a) is a block diagram of a UE which is implemented by means of hardware according to an embodiment of the disclosure;

FIG. 7(b) is a block diagram of a UE which is implemented by means of hardware according to an embodiment of the disclosure;

FIG. 8(a) is a block diagram of a UE which is implemented by means of hardware according to another embodiment of the disclosure;

FIG. 8(b) is a block diagram of a network node which is implemented by means of hardware according to an embodiment of the disclosure;

FIG. 9 is a block diagram of a network node which is implemented by means of hardware according to an embodiment of the disclosure;

FIG. 10 is a block diagram of a network node which is implemented by means of hardware according to another embodiment of the disclosure;

FIG. 11 is a block diagram of a UE which is implemented by means of hardware and software according to an embodiment of the disclosure;

FIG. 12 is a block diagram of a network node which is implemented by means of hardware and software according to an embodiment of the disclosure; and

FIG. 13 is a block diagram of a computer readable medium having stored thereon a computer program comprising computer program code means according to an embodiment of the disclosure.

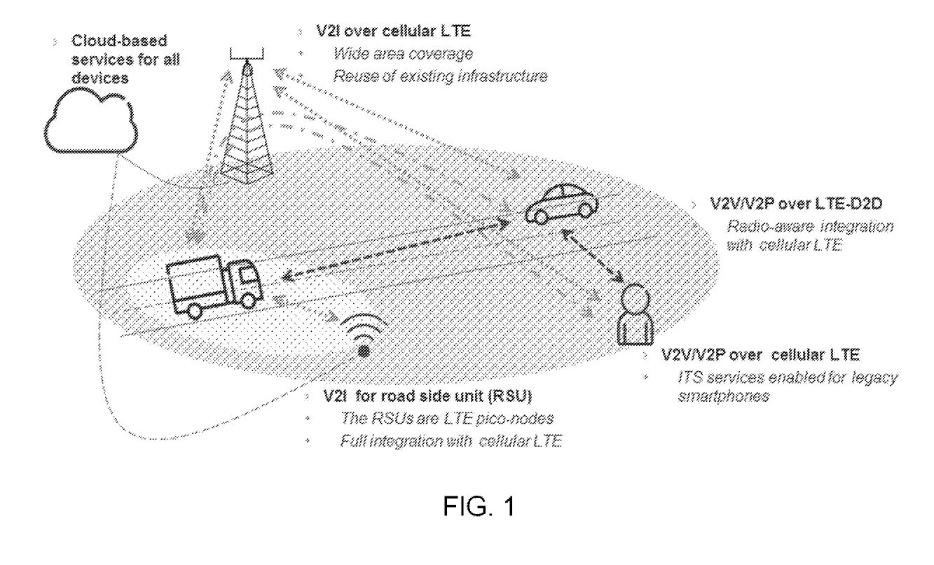

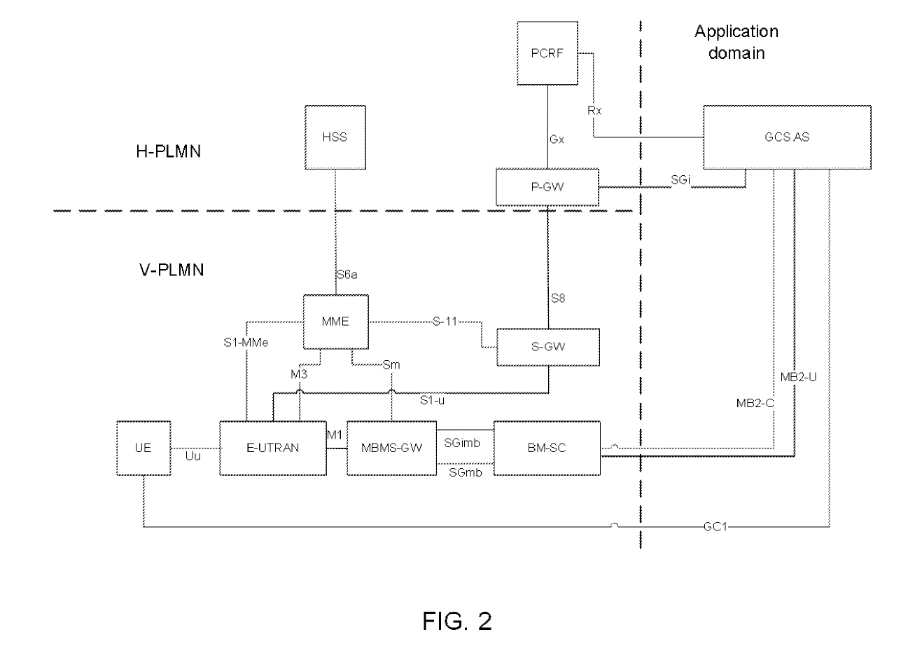

### DETAILED DESCRIPTION

In the discussion that follows, specific details of particular embodiments of the present disclosure are set forth for purposes of explanation and not limitation. It will be appreciated by those skilled in the art that other embodiments may be employed apart from these specific details. Furthermore, in some instances detailed descriptions of well-known methods, nodes, interfaces, circuits, and devices are omitted so as not to obscure the description with unnecessary detail. Those skilled in the art will appreciate that the functions described may be implemented in one or several nodes.

As used herein, the term “user equipment” refers to any device that can access a wireless communication network and receive services therefrom. By way of example and not limitation, a user equipment (UE) may include, but is not limited to, a mobile phone, a cellular phone, a smart phone, a tablet, a wearable device, a personal digital assistant (PDA), and the like.

The term “network node” used herein refers to a device at the network side and may include a network device via which a terminal device accesses the network and receives services therefrom. By way of example, such a network node may be a base station (BS), a node B (NodeB or NB), an evolved NodeB (eNodeB or eNB), a Remote Radio Unit (RRU), a radio header (RH), a remote radio head (RRH), a relay, a low power node such as a femto, a pico, and so forth.

The principle of the disclosure is to provide mechanisms to enable adaption of transmission format/retransmission with cluster wise identifier (or bearer). In the following, the proposed schemes are discussed in the context of MCS/HARQ retransmission adaption for MBMS services in LTE wireless networks. However, one of ordinary skill in the art can understand that it is exemplary only and the scope of the disclosure is not limited thereto. For example, the proposed schemes can also be applied to other broadcast services than the MBMS services.

To adapt MCS/HARQ retransmission per broadcast service, a network node (for example, an eNB in LTE) figures out to which broadcast service the CSI report/HARQ feedback relates or filters out the CSI report/HARQ feedback that corresponded to the same broadcast service. Besides, UE can send HARQ feedback for all the TMGI/mbms bearers from a cell which may generate too much overhead and interference. It is preferable that the UE only sends HARQ feedback for the TMGI/mbms bearer that it is currently actually receiving.

Moreover, with cluster the message may only need to be received when the UE is in specific locations in a cell, i.e. the UE may change interest in receiving a MBMS service more frequently and depending on its location. The current procedure cannot handle this effectively/efficiently where the transmission of MBMS Interest Indication message is only triggered by the changes in the system side and quite some info (interested frequencies, priority, interested services) has to be provided each time the message is transmitted, while not all of them are relevant if the change of interest is just due to change of UE location.

Schemes are proposed to enable MCS/HARQ retransmission adaptation with cluster wise TMGI. The major issue is how to figure out for which TMGI the CSI report/A-N feedback corresponds to. There are two scenarios, the first scenario is where both the bearer (TMGI) to cluster (local area ID) mapping and the cluster definition (i.e. mapping of local area ID to UE positions) are known to UE, the second scenario is that these are known to eNB but not to UE.

Scenario 1

In Scenario 1, both eNB and UE are involved in the MCS/HARQ retransmission adaptation. The eNB knows the bearer (TMGI) to cluster (local area ID) mapping, and informs this mapping to UE by e.g. MCCH. The cluster definition (i.e. mapping of local area ID to UE positions) is limited to APP layer between UE and APP server. The UE could figure out which MBMS service(s) (TMGI(s)) it needs to receive depending on bearer to cluster mapping and cluster definition, and its own location, and then could feedback this to the eNB via MBMS interest indication message. The eNB could then know which TMGI(s) the UE is actually receiving as these are the TMGI(s) that are currently being sent by the eNB. This specific MBMS Interest Indication message could be sent together with CSI or A-N feedback, or using a separate L3 signaling when UE detects the change in MBMS services of interest due to change of its location. For MCS adaption, the major issue is how to figure out for which cluster the CSI report represents. In order to implement this, some indication is needed from the UE.

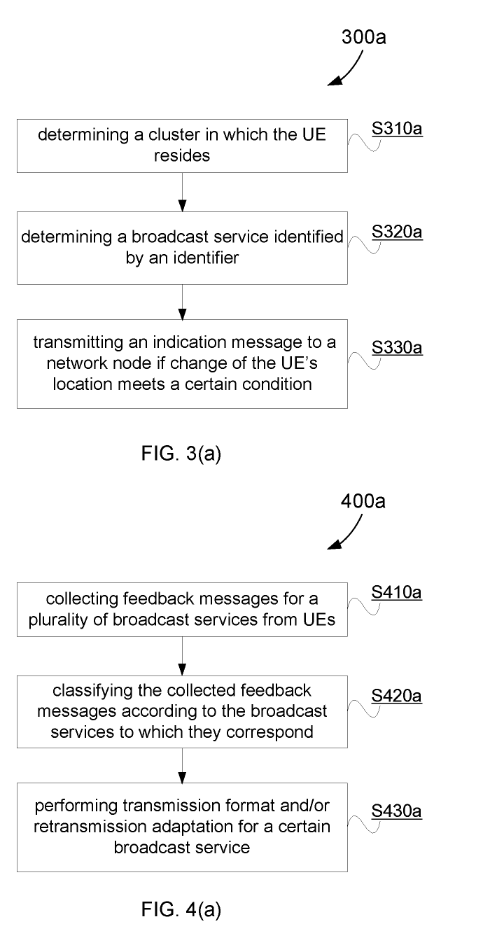

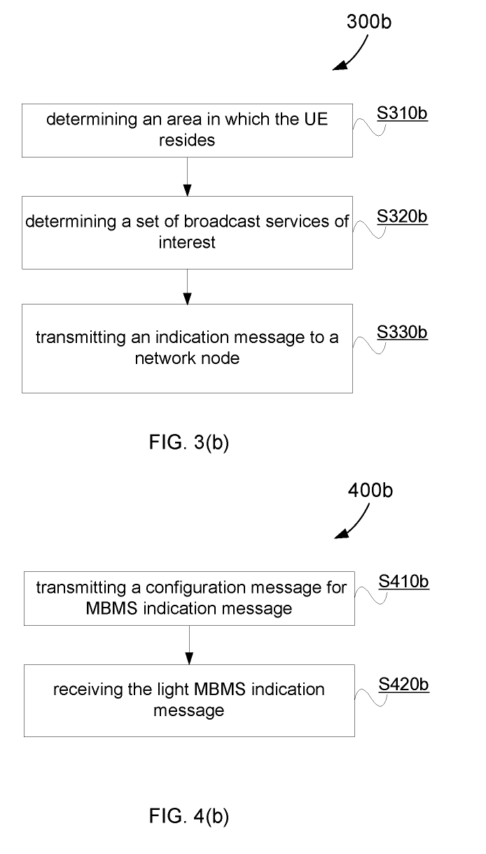

FIG. 3(a) is a flowchart illustrating a method 300a in a UE for transmission format and/or retransmission adaptation according to an embodiment of the disclosure. The method 300a as shown in FIG. 3(a) includes the following steps.

At step S310a, a cluster in which the UE resides is determined based upon the UE's location and cluster definition information. As used herein, the term “cluster” may refer to a local area in the system. The cluster definition information may define relationship between local area IDs (i.e., cluster IDs) and locations.

At step S320a, a broadcast service identified by an identifier which is related to the cluster is determined based upon bearer to cluster mapping information. The broadcast service is the service which the UE should receive or is supposed to receive. The bearer to cluster mapping information defines relationship between local area IDs (i.e., clusters) and TMGI/mbms bears. For example, the broadcast service may be an MBMS service and the bearer may be an MBMS bearer.

At step S330a, an indication message is transmitted to a network node if change of the UE's location meets a certain condition. The indication message may assist the transmission format and/or retransmission adaptation for the broadcast service. For example, the indication message may be transmitted to the network node when the UE changes the cluster that it resides in. Alternatively, the indication message may be transmitted to the network node when broadcast services of interest are changed due to a change of the UE's location.

In an embodiment, the transmission format comprises MCS format and the retransmission comprises HARQ retransmission. The identifier may comprise a Temporary Mobile Group Identity, TMGI.

Moreover, the UE may change MBMS services of interest more frequently when moving, especially when the cluster is relatively small, thus may need to send the MBMS Interest Indication message more frequently. In order to reduce the overhead, a light MBMS Interest Indication message can be introduced which only includes the mbms-Services (no mbms-FreqList and mbms-Priority). The light indication message is transmitted to the network node when: (1) MBMS services of interest are changed due to change of UE's location; (2) a serving cell for the UE is not changed; and (3) the legacy MBMS interest indication message has been sent to the serving cell at least once. When receiving a light MBMS Interest Indication message, the network node could know that the change of MBMS services of interest is purely due to change of UE location.

Furthermore, a local index for mbms-Services could be included in the light MBMS Interest Indication message, which is only unique in the serving cell. Then a mapping between TMGIs available in the cell and the local mbms-Services ID is added. This mapping could be informed to the UE via broadcast, or alternatively it can be defined implicitly, e.g. indicated by the order that the available TMGs are informed to the UE (via SIB 15).

FIG. 3(b) is a flowchart illustrating a method in a UE according to an embodiment of the disclosure. The method 300b as shown in FIG. 3(b) includes the following steps.

At step S310b, an area in which the UE resides is determined based upon the UE's location and area definition information. As used herein, the area definition information may define relationship between local area IDs and locations.

At step S320b, a set of broadcast services of interest is determined based upon the determined area and bearer to area mapping information. The broadcast service is the service which the UE should receive or is supposed to receive. The bearer to area mapping information defines relationship between local area IDs and TMGI/mbms bearers. For example, the broadcast service may be an MBMS service and the bearer may be an MBMS bearer.

At step S330b, an indication message is transmitted to a network node when the set of broadcast services of interest is changed due to a change of the UE's location. For example, the indication message may comprise an MBMS indication message.

In an embodiment, the MBMS indication message may comprise a light MBMS indication message. Preferably, the light MBMS indication message does not include information about MBMS frequencies of interest or priorities thereof. The light MBMS indication message may be transmitted to the network node when MBMS services of interest are changed due to the change of the UE's location and a legacy MBMS indication message has been sent to the network node.

In an embodiment, a configuration message for the light MBMS indication message may be received from the network node, Thus the light MBMS indication message can be configured, based upon the configuration message, to comprise a local index associated with an MBMS service. The local index may be defined by the network node explicitly or implicitly.

FIG. 4(b) is a flowchart illustrating a method in a network node according to an embodiment of the disclosure. The method 400b as shown in FIG. 4(b) includes the following steps.

At step S410b, a configuration message for a light Multimedia

Broadcast/Multicast Service, MBMS, indication message is transmitted to a User Equipment, UE.

At step S420b, the light MBMS indication message is received from the UE. Preferably, the light MBMS indication message does not include information about MBMS frequencies of interest or priorities thereof. The light MBMS indication message may comprise a local index associated with an MBMS service. The local index may be defined by the network node explicitly or implicitly.

FIG. 4(a) is a flowchart illustrating a method in a network node for transmission format and/or retransmission adaptation according to an embodiment of the disclosure. The method 400a as shown in FIG. 4(a) includes the following steps.

At step S410a, feedback messages for a plurality of broadcast services identified by a plurality of identifiers are collected from a plurality of UEs.

At step S420a, the collected feedback messages are classified according to the broadcast services to which they correspond. For example, the classifying may comprise determining the identifiers to which the feedback messages correspond in accordance with certain bits in the feedback messages.

At step S430a, transmission format and/or retransmission adaptation for a certain broadcast service is performed according to the feedback messages classified to that broadcast service. For example, the retransmission adaptation may comprise determining the identifiers which the UEs are receiving according to the classified feedback messages and determining the UEs which receive the identifiers incorrectly. Then, HARQ retransmission adaptation can be performed in consideration of the determined UEs.

For example, for HARQ retransmission adaption, it is preferable that the network node knows exactly which TMGI the HARQ feedback corresponds to. To achieve this some rules could be predefined in A-N feedback messages. For instance, for each UE the nth A-N bit corresponds to the Nth TMGI (ordered by the TMGI number) that the UE is receiving. This could work as both the UE and the network know the TMGI(s) that are currently being received. Thus the network node could know which TMGI is incorrectly received and by how many UEs, and perform HARQ retransmission accordingly. Optionally the UE could only feedback NACK when fails to receive.

On the other hand, transmission format adaptation may comprise determining the identifiers which the UEs are receiving according to the classified feedback messages, and performing MCS format adaptation for a certain identifier according to the classified feedback messages for that identifier. For example, after getting CSI reports from the UEs, the network node (such as an eNB) could collect CSI reports for each (active) TMGI from all the UEs that are receiving this TMGI, and adapt/set MCS for the TMGI based on those CSI accordingly.

Scenario 2

In Scenario 2, both the bearer (TMGI) to cluster (local area ID) mapping and the cluster definition are known to eNB (and APP layer at the APP server), while the UE knows nothing about it. The UE could feedback its location to eNB, and the eNB could figure out which cluster (local area) the UE resides in, consequently could deduce which TMGI(s) the UE may be interested to receive, and which TMGI(s) the UE should currently receive. Correspondingly, the eNB could collect CSI report/HARQ feedback messages for each TMGI from all the UEs that are supposed to receive this TMGI, and adapt MCS/HARQ retransmission for this TMGI accordingly.

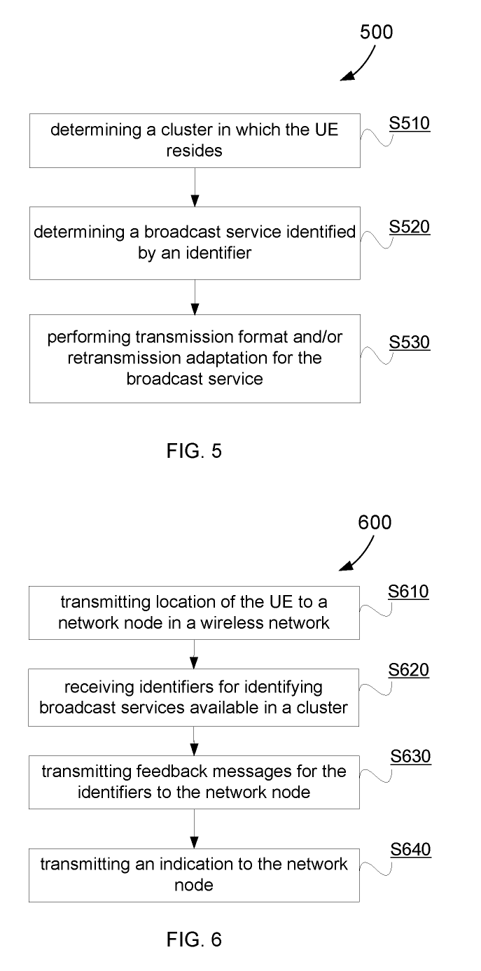

FIG. 5 is a flowchart illustrating a method in a network node for transmission format and/or retransmission adaptation according to an embodiment of the disclosure. The method 500 as shown in FIG. 5 includes the following steps.

At step S510, a cluster in which a UE resides is determined based upon the UE's location and cluster definition information.

At step S520, a broadcast service identified by an identifier is determined based upon bearer to cluster mapping information. The broadcast service shall be received by the UE.

At step S530, transmission format and/or retransmission adaptation is performed for the broadcast service. For example, retransmission adaptation may comprises collecting feedback messages for a plurality of broadcast services identified by a plurality of identifiers from a plurality of UEs, and determining, for each identifier, which of the UEs is supposed to receive the identifier. Then the HARQ retransmission adaptation is performed for a certain identifier according to the feedback messages that are supposed to be for the identifier in consideration.

Similar as those in Scenario 1, the mapping of A-N bit to TMGI can be predefined. For instance, for each UE the Nth A-N bit corresponds to the Nth TMGI (ordered by the TMGI number) that the UE is receiving. However, in Scenario 2, the UE may need to receive all the TMGIs being sent in the cell). In the eNB, the A-N feedback messages will be collected for each TMGI from all the UEs that are supposed to receive this TMGI, and then HARQ retransmission is adapted for this TMGI based on those A-N feedbacks accordingly. The other A-N feedback will be discarded.

On the other hand, transmission format adaptation may comprise determining, for a certain identifier, which UEs are supposed to receive the certain identifier, and performing MCS format adaptation for the certain identifier according to the classified feedback messages for that identifier. For example, after receiving the CSI report from the UE, the eNB could collect CSI report for each TMGI from all the UEs that are supposed to receive this TMGI, and adapt/set MCS for this TMGI based on those CSI accordingly.

In Scenario 2, DL signaling can be saved in RAN but UE may not be able to know which cluster it resides in and which TMGI should monitor. Therefore, the UE may have to send some unnecessary A-N feedback as it does not know which TMGI it should receive. To address this issue, the following method is proposed for UE to determine by itself which TMGI it should receive and for which TMGI it should feedback A-N messages.

FIG. 6 is a flowchart illustrating a method in a UE for transmission format and/or retransmission adaptation according to an embodiment of the disclosure. The method 600 as shown in FIG. 6 includes the following steps.

At step S610, location of the UE is transmitted by the UE to a network node in a wireless network. For example, the location of UE may be transmitted periodically or when change of the UE's location meets a certain condition. The UE's location could be feedback together with CSI or A-N feedback, or using a separate L3 signaling.

At step S620, identifiers for identifying broadcast services available in a cluster or cluster(s) are received by the UE. For HARQ retransmission adaption, the UE has to monitor/receive all the TMGI(s) being sent in the cell as it does not know which TMGI to monitor, even for the TMGI(s) it is not really interested in. However, the network node could deduce the TMGI(s) that are supposed to be received by the UE thus could just only adopt the relevant A-N report.

At step S630, feedback messages for the identifiers are transmitted to the network node.

At step S640, if no retransmission is performed for a certain identifier for which a negative feedback message has been sent, an indication is transmitted by the UE to the network node, indicating that the broadcast service for the certain identifier will no longer be received by the UE.

A-N feedback for all the TMGIs could lead to increased uplink overhead and interference. This could potentially be improved if e.g. HARQ retransmission is performed for a TMGI once any of the UE(s) feedbacks NACK for that specific TMGI. Initially, the UE feedbacks A-N messages for all the TMGIs being sent in the serving cell. When it finds that retransmission is not performed for a TMGI for which it has fed back NACK, it will know that this specific TMGI is not what it needs to receive. Then it could indicate this to the network so that the network also knows that the UE has detected one unnecessary reception. After this the UE could stop receiving this TMGI and consequently also no need to feedback A-N for this TMGI, i.e. less bits will be needed for the A-N feedback. In the end the UE will only need to feedback A-N for the TMGI(s) which are supposed to be received.

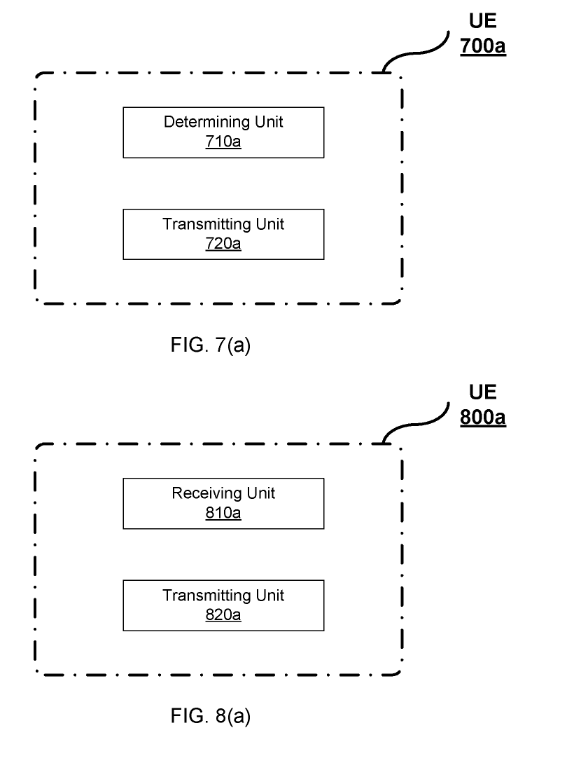

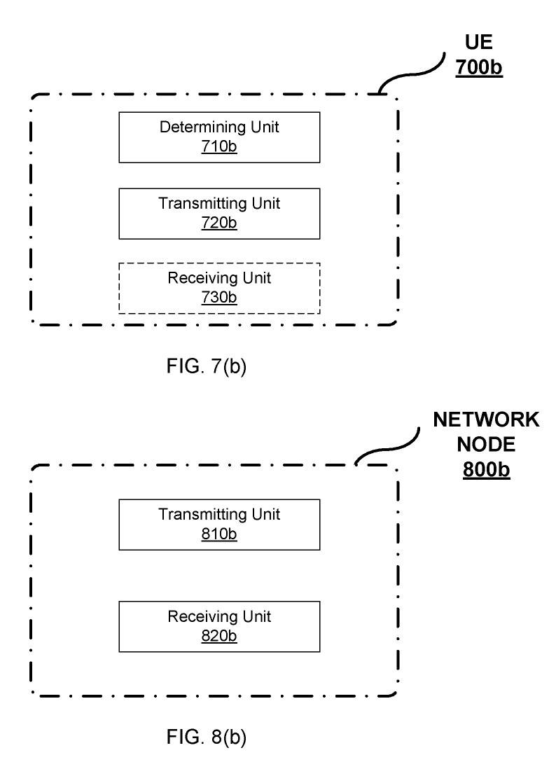

FIG. 7(a) is a block diagram of a UE which is implemented by means of hardware according to an embodiment of the disclosure. As shown in FIG. 7(a), the UE 700a comprises a determining unit 710a and a transmitting unit 720a.

The determining unit 710a is configured to determine a cluster in which the UE resides based upon the UE's location and cluster definition information, and determine a broadcast service identified by an identifier, which the UE should receive or is supposed to receive, based upon bearer to cluster mapping information.

The transmitting unit 720a is configured to transmit an indication message to a network node if change of the UE's location meets a certain condition, the indication message assisting the transmission format and/or retransmission adaptation for the broadcast service.

In an embodiment, the indication message comprises a light MBMS indication message which includes only information about MBMS services of interest. The transmitting unit is configured to transmit the light indication message to the network node when: (1) MBMS services of interest are changed due to change of UE's location; (2) a serving cell for the UE is not changed; and (3) the legacy MBMS interest indication message has been sent to the serving cell.

In an embodiment, the transmitting unit 720a is configured to transmit the indication message to the network node when broadcast services of interest are changed due to a change of the UE's location. Alternatively, the transmitting unit 720a is configured to transmit the indication message to the network node when the UE changes the cluster that it resides in.

FIG. 7(b) is a block diagram of a UE which is implemented by means of hardware according to an embodiment of the disclosure. As shown in FIG. 7(b), the UE 700b comprises a determining unit 710b and a transmitting unit 720b.

The determining unit 710b is configured to determine an area in which the UE resides based upon the UE's location and area definition information, and determine a set of broadcast services of interest based upon the determined area and bearer to area mapping information. As used herein, the area definition information may define relationship between local area IDs and locations. The bearer to area mapping information may define relationship between local area IDs and TMGI/mbms bears.

The transmitting unit 720b is configured to transmit an indication message to a network node when the set of broadcast services of interest is changed due to a change of the UE's location.

In an embodiment, the broadcast services may comprise MBMS services and the indication message may comprise MBMS indication message. Further, the MBMS indication message may comprise a light MBMS indication message. Preferably, the light MBMS indication message does not include information about MBMS frequencies of interest or priorities thereof.

The transmitting unit 720b may be configured to transmit the light MBMS indication message to the network node when MBMS services of interest are changed due to the change of the UE's location and a legacy MBMS indication message has been sent to the network node.

In an embodiment, the UE 700b may further comprise a receiving unit 730b configured to receive, from the network node, a configuration message for the light MBMS indication message. Thus, the light MBMS indication message can be configured, based upon the configuration message, to comprise a local index associated with an MBMS service. The local index may be defined by the network node explicitly or implicitly.

FIG. 8(b) is a block diagram of a network node which is implemented by means of hardware according to an embodiment of the disclosure. As shown in FIG. 8(b), the network node 800b comprises a transmitting unit 810b and a receiving unit 820b.

The transmitting unit 810b is configured to transmit, to a User Equipment, UE, a configuration message for a light Multimedia Broadcast/Multicast Service, MBMS, indication message.

The receiving unit 820b is configured to receive, from the UE, the light MBMS indication message.

Preferably, the light MBMS indication message does not include information about MBMS frequencies of interest or priorities thereof. The light MBMS indication message may comprise a local index associated with an MBMS service.

The local index may be defined by the network node explicitly or implicitly. FIG. 8(a) is a block diagram of a UE which is implemented by means of hardware according to another embodiment of the disclosure. As shown in FIG. 8(a), the UE 800a comprises a receiving unit 810a and a transmitting unit 820a.

The receiving unit 810a is configured to receive identifiers for identifying broadcast services available in a cluster or cluster(s).

The transmitting unit 820a is configured to transmit location of the UE to a network node in a wireless network, transmit feedback messages for the identifiers to the network node, and transmit, if no retransmission is performed for a certain identifier for which a negative feedback message has been sent, an indication to the network node that the broadcast service for the certain identifier will no longer be received by the UE.

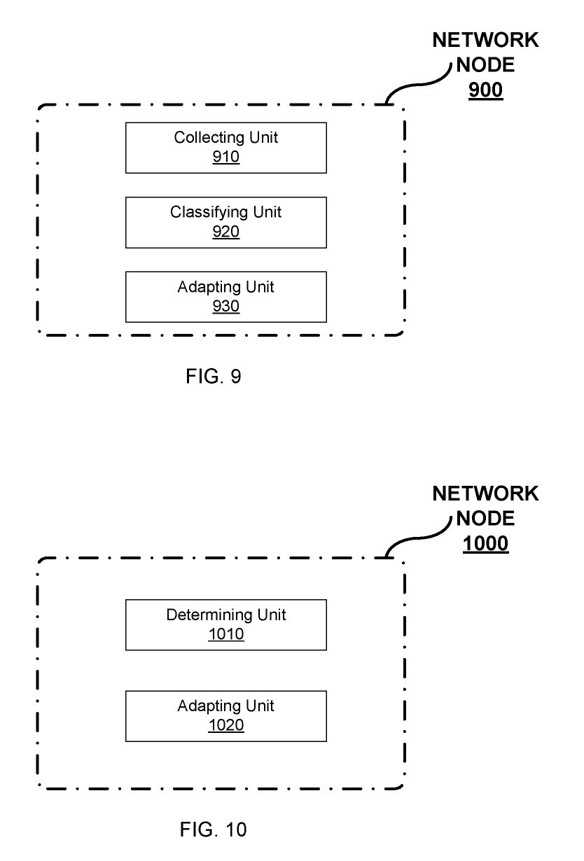

In an embodiment, the transmitting unit 820a is configured to transmit location of UE periodically or when change of the UE's location meets a certain condition. FIG. 9 is a block diagram of a network node which is implemented by means of hardware according to an embodiment of the disclosure. As shown in FIG. 9, the network node 900 comprises a collecting unit 910, a classifying unit 920, and an adapting unit 930.

The collecting unit 910 is configured to collect, from a plurality of UEs, feedback messages for a plurality of broadcast services identified by a plurality of identifiers.

In an embodiment, the classifying unit 910 is further configured to determine the identifiers to which the feedback messages correspond in accordance with certain bits in the feedback messages.

The classifying unit 920 is configured to classify the collected feedback messages according to the broadcast services to which they correspond.

The adapting unit 930 is configured to perform transmission format and/or retransmission adaptation for a certain broadcast service according to the feedback messages classified to that broadcast service.

In an embodiment, the adapting unit 930 is further configured to determine the identifiers which the UEs are receiving according to the classified feedback messages, determine the UEs which receive the identifiers incorrectly, and perform HARQ retransmission adaptation in consideration of the determined UEs. Alternatively, the adapting unit 930 is further configured to determine the identifiers which the UEs are receiving according to the classified feedback messages, and perform MCS format adaptation for a certain identifier according to the classified feedback messages for that identifier.

FIG. 10 is a block diagram of a network node which is implemented by means of hardware according to another embodiment of the disclosure. As shown in FIG. 10, the network node 1000 comprises a determining unit 1010 and an adapting unit 1020.

The determining unit 1010 is configured to determine a cluster in which a User Equipment, UE, resides based upon the UE's location and cluster definition information, and determine a broadcast service identified by an identifier, which shall be received by the UE, based upon bearer to cluster mapping information. The adapting unit 1020 is configured to perform transmission format and/or retransmission adaptation for the broadcast service.

In an embodiment, the adapting unit 1020 is configured to collect, from a plurality of UEs, feedback messages for a plurality of broadcast services identified by a plurality of identifiers, determine, for each identifier, which of the UEs is supposed to receive the identifier, and perform HARQ retransmission adaptation for a certain identifier according to the feedback messages that are supposed to be for the identifier in consideration. Alternatively, the adapting unit 1020 is configured to determine, for a certain identifier, which UEs are supposed to receive the certain identifier, and perform MCS format adaptation for the certain identifier according to the classified feedback messages for that identifier.

As those skilled in the art will appreciate, the above-described units of the network node and UE may be implemented separately as suitable dedicated circuits. Nevertheless, these units can also be implemented using any number of dedicated circuits through functional combination or separation. In some embodiments, these units may be even combined in a single application specific integrated circuit (ASIC).

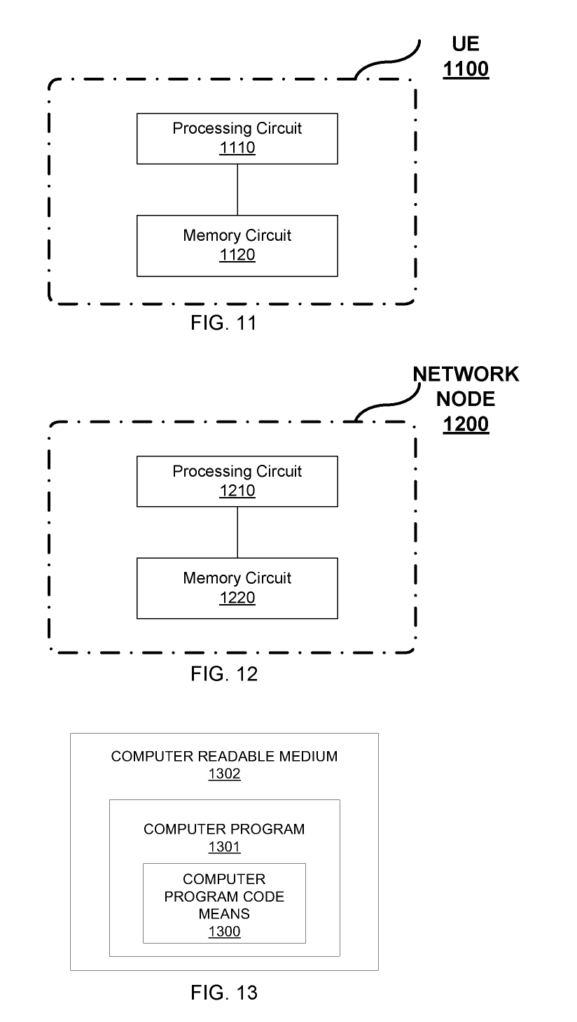

FIG. 11 is a block diagram of a UE which is implemented by means of hardware and software according to an embodiment of the disclosure. As an alternative software-based implementation, there is provided a UE 1100 including a processing circuit 1110 and a memory circuit 1120 storing instructions executable by the processing circuit 1110. The processing circuit 1110 may be implemented by a CPU (Central processing unit), and could also be implemented by other types of components. For example, the processing circuit 1110 may be implemented by general purpose microprocessors, instruction set processors and/or special purpose microprocessors such as Application Specific Integrated Circuit (ASICs).

FIG. 12 is a block diagram of a network node which is implemented by means of hardware and software according to an embodiment of the disclosure. As an alternative software-based implementation, there is provided a network node 1200 including a processing circuit 1210 and a memory circuit 1220 storing instructions executable by the processing circuit 1210. The processing circuit 1210 may be implemented by a CPU (Central processing unit), and could also be implemented by other types of components. For example, the processing circuit 1210 may be implemented by general purpose microprocessors, instruction set processors and/or special purpose microprocessors such as Application Specific Integrated Circuit (ASICs).

The embodiments of the disclosure can be implemented in computer program products. This arrangement of the disclosure is typically provided as software, codes and/or other data structures provided or coded on a computer readable medium (such as an optical medium, e.g., CD-ROM, a floppy disk or a hard disk), or firmware or micro codes on other mediums (such as one or more ROMs, RAMs or PROM chips), or downloadable software images or shared databases in one or more modules.

FIG. 13 is a block diagram of a computer readable medium having stored there on a computer program comprising computer program code means according to an embodiment of the disclosure. As shown in FIG. 13, a computer readable medium 1302 has stored there on a computer program 1301. The computer program 1301 comprises computer program code means 1300 for performing, when executed by at least one processor, the methods according to the disclosure as mentioned above. The computer readable medium 1302 may have the form of a non-volatile or volatile memory, e.g., an Electrically Erasable Programmable Read-Only Memory (EEPROM), a flash memory, a floppy disk, and a hard drive, etc. The computer program code means 1300 may include codes/computer readable instructions in any format.

Part of the above exemplary embodiments can be described, but not limited to, as follows.

In an exemplary embodiment, a method in a User Equipment, UE, for transmission format and/or retransmission adaptation is provided. The method may comprise determining a cluster in which the UE resides based upon the UE's location and cluster definition information. The method may further comprise determining a broadcast service identified by an identifier, which the UE should receive or is supposed to receive, based upon bearer to cluster mapping information. The method may further comprise transmitting an indication message to a network node if change of the UE's location meets a certain condition, the indication message assisting the transmission format and/or retransmission adaptation for the broadcast service.

Alternatively, the broadcast service may comprise Multimedia Broadcast/Multicast Service, MBMS. The bearer may comprise MBMS bearer. The indication message may comprise a light MBMS indication message which includes only information about MBMS services of interest.

Alternatively, the light indication message may be transmitted to the network node when MBMS services of interest are changed due to change of UE's location, a serving cell for the UE is not changed, and the legacy MBMS interest indication message has been sent to the serving cell.

Alternatively, the indication message may be transmitted to the network node when broadcast services of interest are changed due to a change of the UE's location.

Alternatively, the indication message may be transmitted to the network node when the UE changes the cluster that it resides in.

Alternatively, the transmission format may comprise MCS format. The retransmission may comprise HARQ retransmission. The identifier may comprise a Temporary Mobile Group Identity, TMGI.

Alternatively, the light MBMS indication message may further comprise a local index associated with an MBMS service. The local index may be predefined or defined implicitly.

In another exemplary embodiment, a method in a User Equipment, UE, for transmission format and/or retransmission adaptation is provided. The method may comprise transmitting location of the UE to a network node in a wireless network, receiving identifiers for identifying broadcast services available in a cluster or cluster(s), transmitting feedback messages for the identifiers to the network node, and transmitting, if no retransmission is performed for a certain identifier for which a negative feedback message has been sent, an indication to the network node that the broadcast service for the certain identifier will no longer be received by the UE.

Alternatively, the location of UE may be transmitted periodically or when change of the UE's location meets a certain condition.

Alternatively, the identifier may comprise a Temporary Mobile Group Identity, TMGI. The broadcast service may comprise Multimedia Broadcast/Multicast Service, MBMS.

In another exemplary embodiment, a User Equipment, UE, is provided. The UE may comprise a determining unit configured to determine a cluster in which the UE resides based upon the UE's location and cluster definition information, and determine a broadcast service identified by an identifier, which the UE should receive or is supposed to receive, based upon bearer to cluster mapping information. The UE may further comprise a transmitting unit configured to transmit an indication message to a network node if change of the UE's location meets a certain condition, the indication message assisting the transmission format and/or retransmission adaptation for the broadcast service.

Alternatively, the broadcast service may comprise Multimedia Broadcast/Multicast Service, MBMS. The bearer may comprise MBMS bearer. The indication message may comprise a light MBMS indication message which includes only information about MBMS services of interest.

Alternatively, the transmitting unit may be configured to transmit the light indication message to the network node when MBMS services of interest are changed due to change of UE's location, a serving cell for the UE is not changed, and the legacy MBMS interest indication message has been sent to the serving cell.

Alternatively, the transmitting unit may be configured to transmit the indication message to the network node when broadcast services of interest are changed due to a change of the UE's location.

Alternatively, the transmitting unit may be configured to transmit the indication message to the network node when the UE changes the cluster that it resides in. Alternatively, the transmission format may comprise MCS format. The retransmission may comprise HARQ retransmission. The identifier may comprise a Temporary Mobile Group Identity, TMGI.

Alternatively, the light MBMS indication message may further comprise a local index associated with an MBMS service. The local index may be predefined or defined implicitly.

In another exemplary embodiment, a User Equipment, UE, is provided. The UE may comprise a receiving unit configured to receive identifiers for identifying broadcast services available in a cluster or cluster(s). The UE may further comprise a transmitting unit configured to transmit location of the UE to a network node in a wireless network, transmit feedback messages for the identifiers to the network node, and transmit, if no retransmission is performed for a certain identifier for which a negative feedback message has been sent, an indication to the network node that the broadcast service for the certain identifier will no longer be received by the UE.

Alternatively, the transmitting unit may be configured to transmit location of UE periodically or when change of the UE's location meets a certain condition. Alternatively, the identifier may comprise a Temporary Mobile Group Identity, TMGI. The broadcast service may comprise Multimedia Broadcast/Multicast Service, MBMS.

In another exemplary embodiment, a method in a network node for transmission format and/or retransmission adaptation is provided. The method may comprise collecting, from a plurality of User Equipments, UEs, feedback messages for a plurality of broadcast services identified by a plurality of identifiers. The method may further comprise classifying the collected feedback messages according to the broadcast services to which they correspond. The method may further comprise performing transmission format and/or retransmission adaptation for a certain broadcast service according to the feedback messages classified to that broadcast service.

Alternatively, classifying the collected feedback messages may comprise determining the identifiers to which the feedback messages correspond in accordance with certain bits in the feedback messages.

Alternatively, performing retransmission adaptation may comprise determining the identifiers which the UEs are receiving according to the classified feedback messages, determining the UEs which receive the identifiers incorrectly, and performing HARQ retransmission adaptation in consideration of the determined UEs.

Alternatively, performing transmission format adaptation may comprise determining the identifiers which the UEs are receiving according to the classified feedback messages, and performing MCS format adaptation for a certain identifier according to the classified feedback messages for that identifier.

Alternatively, the identifier may comprise a Temporary Mobile Group Identity, TMGI. The broadcast service may comprise Multimedia Broadcast/Multicast Service, MBMS. The feedback messages may comprise CSI reports.

In another exemplary embodiment, a method in a network node for transmission format and/or retransmission adaptation is provided. The method may comprise determining a cluster in which a User Equipment, UE, resides based upon the UE's location and cluster definition information. The method may further comprise determining a broadcast service identified by an identifier, which shall be received by the UE, based upon bearer to cluster mapping information. The method may further comprise performing transmission format and/or retransmission adaptation for the broadcast service.

Alternatively, performing retransmission adaptation may comprise collecting from a plurality of User Equipments, UEs, feedback messages for a plurality of broadcast services identified by a plurality of identifiers, determining for each identifier which of the UEs is supposed to receive the identifier, and performing HARQ retransmission adaptation for a certain identifier according to the feedback messages that are supposed to be for the identifier in consideration.

Alternatively, performing transmission format adaptation may comprise determining, for a certain identifier, which UEs are supposed to receive the certain identifier, and performing MCS format adaptation for the certain identifier according to the classified feedback messages for that identifier.

Alternatively, the identifier may comprise a Temporary Mobile Group Identity, TMGI. The broadcast service may comprise Multimedia Broadcast/Multicast Service, MBMS. The feedback messages may comprise CSI reports.

In another exemplary embodiment, a network node for transmission format and/or retransmission adaptation is provided. The network node may comprise a collecting unit configured to collect, from a plurality of User Equipments, UEs, feedback messages for a plurality of broadcast services identified by a plurality of identifiers. The network node may further comprise a classifying unit configured to classify the collected feedback messages according to the broadcast services to which they correspond. The network node may further comprise an adapting unit configured to perform transmission format and/or retransmission adaptation for a certain broadcast service according to the feedback messages classified to that broadcast service.

Alternatively, the classifying unit may be further configured to determine the identifiers to which the feedback messages correspond in accordance with certain bits in the feedback messages.

Alternatively, the adapting unit may be further configured to determine the identifiers which the UEs are receiving according to the classified feedback messages, determine the UEs which receive the identifiers incorrectly, and perform HARQ retransmission adaptation in consideration of the determined UEs. Alternatively, the adapting unit may be further configured to determine the identifiers which the UEs are receiving according to the classified feedback messages, and perform MCS format adaptation for a certain identifier according to the classified feedback messages for that identifier.

Alternatively, the identifier may comprise a Temporary Mobile Group Identity, TMGI. The broadcast service may comprise Multimedia Broadcast/Multicast Service, MBMS. The feedback messages may comprise CSI reports.

In another exemplary embodiment, a network node for transmission format and/or retransmission adaptation is provided. The network node may comprise a determining unit configured to determine a cluster in which a User Equipment, UE, resides based upon the UE's location and cluster definition information, and determine a broadcast service identified by an identifier, which shall be received by the UE, based upon bearer to cluster mapping information. The network node may further comprise an adapting unit configured to perform transmission format and/or retransmission adaptation for the broadcast service.

Alternatively, the adapting unit may be configured to collect, from a plurality of User Equipments, UEs, feedback messages for a plurality of broadcast services identified by a plurality of identifiers, determine, for each identifier, which of the UEs is supposed to receive the identifier, and perform HARQ retransmission adaptation for a certain identifier according to the feedback messages that are supposed to be for the identifier in consideration.

Alternatively, the adapting unit may be configured to determine, for a certain identifier, which UEs are supposed to receive the certain identifier, and perform MCS format adaptation for the certain identifier according to the classified feedback messages for that identifier.

Alternatively, the identifier may comprise a Temporary Mobile Group Identity, TMGI. The broadcast service may comprise Multimedia Broadcast/Multicast Service, MBMS. The feedback messages may comprise CSI reports.

In another exemplary embodiment, a network node is provided. The network node may comprisea processing circuit and a memory circuit. The memory circuit may contain instructions executable by the processing circuit whereby the network node is operative to perform the methods for network node described herein.

In another exemplary embodiment, a user equipment, UE, is provided. The UE may comprise a processing circuit and a memory circuit. The memory circuit may contain instructions executable by the processing circuit whereby the UE is operative to perform the methods for UE described herein.

In another exemplary embodiment, a computer program is provided which may comprise computer program code means which, when executed on at least one processing circuit, cause the at least one processing circuit to carry out the methods described herein.

In another exemplary embodiment, a computer readable medium is provided which has stored thereon the computer program described herein.

Conditional language used herein, such as “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open- ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list. Further, the term “each,” as used herein, in addition to having its ordinary meaning, can mean any subset of a set of elements to which the term “each” is applied.

The terms “first” and “second” refer to different elements. The singular forms “a” and “an” are intended to include the plural forms as well, unless the context clearly indicates otherwise. The term “based on” is to be read as “based at least in part on.” The term “one embodiment” and “an embodiment” are to be read as “at least one embodiment.” The term “another embodiment” is to be read as “at least one other embodiment.” Other definitions, explicit and implicit, may be included below.

In addition, language such as the phrase “at least one of X, Y and Z,” unless specifically stated otherwise, is to be understood with the context as used in general to convey that an item, term, etc. may be either X, Y, or Z, or a combination thereof. Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations.

The disclosure has been described with reference to embodiments and drawings.

It should be understood that various modifications, alternations and additions can be made by those skilled in the art without departing from the spirits and scope of the disclosure. Therefore, the scope of the disclosure is not limited to the above particular embodiments but only defined by the claims as attached and equivalents thereof.

1-26. (canceled)

27. A method in a User Equipment (UE), the method comprising:
determining an area in which the UE resides, based upon the UE's location and area definition information;
determining a set of broadcast services of interest, based upon the determined area and bearer to area mapping information; and
transmitting an indication message to a network node responsive to determining that the set of broadcast services of interest is changed due to a change of the UE's location.

28. The method according to claim 27, wherein the set of broadcast services comprises a Multimedia Broadcast/Multicast Service (MBMS), the bearer comprises an MBMS bearer, and the indication message comprises an MBMS indication message.

29. The method according to claim 28, wherein the MBMS indication message comprises a light MBMS indication message, and wherein the light MBMS indication message does not include information about MBMS frequencies of interest or priorities thereof.

30. The method according to claim 29, wherein the light MBMS indication message is transmitted to the network node when MBMS services of interest are changed due to the change of the UE's location and a legacy MBMS indication message has been sent to the network node.

31. The method according to claim 29, further comprising receiving, from the network node, a configuration message for the light MBMS indication message.

32. The method according to claim 31, wherein the light MBMS indication message is configured, based upon the configuration message, to comprise a local index associated with an MBMS service.

33. The method according to claim 32, wherein the local index is defined by the network node explicitly or implicitly.

34. A User Equipment (UE), comprising:
processing circuitry; and
a memory comprising instructions executable by the processing circuitry, whereby the UE is operative to:
determine an area in which the UE resides based upon the UE's location and area definition information, and determine a set of broadcast services of interest based upon the determined area and bearer to area mapping information; and
transmit an indication message to a network node responsive to determining that the set of broadcast services of interest is changed due to a change of the UE's location.

35. The UE according to claim 34, wherein the set of broadcast services comprises a Multimedia Broadcast/Multicast Service (MBMS), the bearer comprises an MBMS bearer, and the indication message comprises an MBMS indication message.

36. The UE according to claim 35, wherein the MBMS indication message comprises a light MBMS indication message, and wherein the light MBMS indication message does not include information about MBMS frequencies of interest or priorities thereof.

37. The UE according to claim 36, wherein the memory comprises instructions whereby the UE is operative to transmit the light MBMS indication message to the network node when MBMS services of interest are changed due to the change of the UE's location and a legacy MBMS indication message has been sent to the network node.

38. The UE according to claim 36, wherein the memory comprises instructions whereby the UE is operative to receive, from the network node, a configuration message for the light MBMS indication message.

39. The UE according to claim 38, wherein the light MBMS indication message is configured, based upon the configuration message, to comprise a local index associated with an MBMS service.

40. The UE according to claim 39, wherein the local index is defined by the network node explicitly or implicitly.

41. A method in a network node, the method comprising:
transmitting, to a User Equipment (UE), a configuration message for a light Multimedia Broadcast/Multicast Service (MBMS) indication message, wherein the light MBMS indication message does not include information about MBMS frequencies of interest or priorities thereof; and
receiving, from the UE, the light MBMS indication message.

42. The method according to claim 41, wherein the light MBMS indication message comprises a local index associated with an MBMS service.

43. The method according to claim 42, wherein the local index is defined by the network node explicitly or implicitly.

44. A network node, comprising:
processing circuitry; and
a memory comprising instructions executable by the processing circuitry, whereby the network node is operative to:
transmit, to a User Equipment (UE), a configuration message for a light Multimedia Broadcast/Multicast Service (MBMS) indication message, wherein the light MBMS indication message does not include information about MBMS frequencies of interest or priorities thereof; and
receive, from the UE, the light MBMS indication message.

45. The network node according to claim 44, wherein the light MBMS indication message comprises a local index associated with an MBMS service.

46. The network node according to claim 45, wherein the local index is defined by the network node explicitly or implicitly.
